(19) United States
(12) Patent Application Publication
(10) Pub. No.: US 2024/0075331 A1
(43) Pub. Date: Mar. 7, 2024

(54) NANOPARTICLE STABILIZED FIREFIGHTING FOAMS

(71) Applicant: PERIMETER SOLUTIONS LP, Clayton, MO (US)

(72) Inventors: Leilei ZHANG, Green Bay, WI (US); Pamela HAVELKA-RIVARD, De Pere, WI (US); Monica AMANDI, Mieres (ES); Covadonga PEREZ, Mieres (ES); Melissa KIM, Ontario, CA (US)

(21) Appl. No.: 18/241,495

(22) Filed: Sep. 1, 2023

Related U.S. Application Data
(60) Provisional application No. 63/403,510, filed on Sep. 2, 2022.

(51) Int. Cl. A62D 1/02

(52) U.S. Cl. CPC A62D 1/0071

(57) ABSTRACT

The present invention is generally directed to nanoparticle stabilized firefighting foam concentrates, firefighting foam solutions, and firefighting foams prepared from a concentrate or solution of the present invention containing one or more silica nanoparticles (e.g., surface modified silica nanoparticles) and any or all of one or more components selected from one or more organic solvents, one or more surfactants, one or more biopolymers, and one or more alcohols. The present invention is also directed to methods for increasing the resistance of a firefighting foam to a polar solvent. The present invention is further directed to methods for preparing firefighting foam concentrates including silica nanoparticles (e.g., surface modified silica nanoparticles).

### REFERENCE TO RELATED APPLICATIONS

This application claims the benefit of and priority to U.S. Provisional Patent Application Ser. No. 63/403,510, filed Sep. 2, 2022, the entire contents of which are hereby incorporated by reference for all relevant purposes.

### FIELD OF THE INVENTION

The present invention is generally directed to nanoparticle stabilized firefighting foam concentrates, firefighting foam solutions, and firefighting foams prepared from a concentrate or solution of the present invention containing one or more silica nanoparticles (e.g., surface modified silica nanoparticles) and any or all of one or more components selected from one or more organic solvents, one or more surfactants, one or more biopolymers, and one or more alcohols. The present invention is also directed to methods for increasing the resistance of a firefighting foam to a polar solvent. The present invention is further directed to methods for preparing firefighting foam concentrates including silica nanoparticles (e.g., surface modified silica nanoparticles).

### BACKGROUND OF THE INVENTION

Aqueous firefighting foams are used against Class B fires (i.e., fires fueled by flammable liquids). Such firefighting foams include both aqueous film-forming foams (AFFF) and alcohol-resistant aqueous film-forming foams (AR-AFFF). In recent years, due to toxicity concerns fluorine free aqueous firefighting foams have been developed. Suitable fluorine-free foams have been developed. But opportunities for improvements in such foams do exist.

For example, certain fluorine free foams utilize silicon-based surfactants, which may be undesired for toxicity reasons. Accordingly, effective silicon free fluorine free foams may be desirable under certain circumstances.

One important use of fluorine free firefighting foams is in connection with polar solvent (e.g., isopropyl alcohol) fuel fires. The polymers in foam formulation seal the surface of fuel thereby suppressing vapor release and separating the fuel and air to extinguish the fire. Effective alcohol-containing foams (e.g., prepared from alcohol type concentrates, ATC) have been prepared that include additives to prevent the polar solvent from mixing with the water in the foam bubbles and destroying the blanket. While such foams are effective, similarly performing foams that may not require certain additives may be desired. For example, foams exhibiting such resistance have been prepared, but typically include a fatty alcohol defoamer. While effective foams containing alcohol components have been utilized, in certain situations a fatty alcohol defoamer may weaken the foam generated. Therefore, effective (fluorine free) firefighting foams that do not require an alcohol component may be desired under certain circumstances.

Concentrates for use in firefighting foams are typically tested for their foaming properties in connection with different water sources, including fresh and salt water (e.g., sea water, including sea water having high total suspended solids). Foams exhibiting suitable performance in connection with multiple sources are desired, for example, to provide flexibility in use.

### BRIEF SUMMARY OF THE INVENTION

Briefly, therefore, certain embodiments of the present invention are directed to firefighting foam concentrates comprising silica nanoparticles (e.g., surface modified silica nanoparticles), wherein the silica nanoparticles have a silica (SiO₂) content of at least about 50 wt %; one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 dipropionate surfactants, and combinations thereof; optionally, one or more biopolymers; and optionally, one or more alcohols, wherein the one or more alcohols are selected from the group consisting of C6-C16 linear alcohols, C6-C16 branched alcohols, and combinations thereof.

Various aspects of the present invention are also directed to firefighting foam concentrates comprising: silica nanoparticles (e.g., surface modified silica nanoparticles), wherein the silica nanoparticles comprise silica (SiO₂) and a clay component comprising alumina (Al₂O₃), kaolinite (Al₂Si₂O₅(OH)₄), or a combination thereof; one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, dipropionate surfactants, and combinations thereof; optionally, one or more biopolymers; and optionally, one or more alcohols, wherein the one or more alcohols are selected from the group consisting of C6-C16 linear alcohols, C6-C16 branched alcohols, and combinations thereof.

Certain aspects of the present invention are directed to a firefighting foam concentrate, the concentrate comprising: surface modified silica nanoparticles, wherein the silica nanoparticles have a silica (SiO₂) content of at least about 50 wt %; one or more organic solvents, wherein the one or more organic solvents comprise one or more glycols and/or one or more glycol ethers; anionic surfactants comprising: (i) a first anionic surfactant comprising a C8-C22 sulfonate surfactant, and/or a C8-C22 sulfate surfactant, and (ii) a second anionic surfactant comprising a branched ethoxylated sulfate C8-C16 sulfate surfactant, and/or a linear ethoxylated sulfate C8-C16 surfactant; amphoteric surfactants comprising a C8-C22 betaine surfactant, and a C8-C22 sultaine surfactant, and optionally, one or more biopolymers; and optionally, one or more alcohols, wherein the one or more alcohols are selected from the group consisting of C6-C16 linear alcohols, C6-C16 branched alcohols, and combinations thereof.

The present invention is also directed to firefighting foam solutions prepared from any of the concentrates of the present invention.

Aspects of the present invention are also directed to firefighting foam compositions prepared from any of the concentrates or solutions of the present claims, wherein the foam composition: satisfies nonpolar fuel (heptane) fire testing in fresh water and sea water under UL standard 162; and/or exhibits foam expansion ratio of at least about 5 when lab tested in accordance with UL standard 162 for a premix solution containing one or more surface modified nanoparticles in a concentration in the range of from 30 ppm to 1500 ppm; and/or exhibits foam expansion of at least 9% (or from about 10% to about 20%) when testing in sea water and sea water containing high suspended solids (HSS) in accordance with ASTM D1141-98; and/or satisfies one or more standards listed in International Civil Aviation Organization (ICAO) Airport Services Manual, 4^{th} edition, 2015: and/or UL 162 Standard for foam equipment and Liquid Concentrates (8^{th} edition).

Still further aspects of the present invention are directed to methods for preparing a firefighting foam concentrate, the method comprising: preparing one or more surface modified nanoparticles by combining one or more silica containing nanoparticles, a compound containing a silane group, and a grafting polymer, wherein the one or silane groups are selected from alkyl silanes, amino silanes, acrylic silanes, vinyl silanes, and combinations thereof, and the grafting polymer is selected from poly(lactide) (PLA), poly(lactide-co-glycolide) (PLGA) copolymers, poly (ε-caprolactone) (PCL), poly (amino acids), alginate, chitosan, gelatin, albumin, and combinations thereof; and combining the one or more surface modified nanoparticles with one or more other components of the firefighting foam concentrate. The one or more other components selected from the group consisting of: one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 alkyl-iminodipropionate surfactants, and combinations thereof; one or more biopolymers; and one or more alcohols, wherein the one or more alcohols are selected from the group consisting of C6-C16 linear alcohols, C6-C16 branched alcohols, and combinations thereof.

These and various embodiments of the present invention are directed to such firefighting foams which are fluorine free, silicon free, and/or hydrocarbon surfactant based.

Other objects and features will be in part apparent and in part pointed out hereinafter.

### BRIEF DESCRIPTION OF THE FIGURES

FIG. 1 provides the results of foamability of solubility testing for Samples 1-9 described in Example 1.

FIG. 2 provides stability testing for Sample 10 (including chemically prepared silica nanoparticles) at concentrations of 34000 parts per million (ppm), 3400 ppm, 340 ppm, and 34 ppm (L-R) after storage for 15 hours.

FIG. 3 provides the results of testing the effect of nanoparticle concentration (340 ppm or 3400 ppm) on foam expansion (volume) for alkyl modified nanoparticles (Sample 10).

FIG. 4 provides the results of testing for polar fuel (isopropyl alcohol (IPA)) resistance (foam stability in seconds (sec)) for various samples based on Formulation 1.

### DETAILED DESCRIPTION OF THE INVENTION

Described herein are firefighting foam concentrates, solutions, and foams that exhibit one or more advantageous properties. For example, various embodiments of the present invention exhibit improved foam expansion and flash foaming properties. Embodiments of the present invention are also believed to provide improved resistance to polar fuels (e.g., isopropyl alcohol) including such compositions that do not require the presence of short-chain or long-chain alcohols. Embodiments of the present invention also provide foams exhibiting improved fire testing performance when subjected to Underwriters Laboratory (UL) testing. Advantageously this improved performance has been exhibited in connection with various water sources and under various conditions.

Embodiments of the present invention include firefighting foams for use against Class B fires (e.g., aqueous film-forming foams (AFFF) and alcohol-resistant aqueous film-forming foams (AR-AFFF)). Various embodiments also include fluorine-free foams.

In addition to characterization by their effectiveness, performance properties, and components, compositions of the present invention (e.g., firefighting foam concentrates, firefighting foam solutions, and firefighting foams) may be characterized as silicone-free, hydrocarbon-surfactant based and free of any fatty alcohol defoamer.

Generally, the compositions of the present invention include one or more surface modified silica nanoparticles along with one or more other components selected from one or more organic solvents, one or more surfactants, one or more biopolymers, and one or more alcohols.

Nanoparticles

Without being bound to any particular theory, it is currently believed the nanoparticles are surface active, thus improving the foamability properties of the formulations. Such performance is described herein, including in the working examples both generally and in certain instances for formulations in the absence a fatty alcohol defoamer.

Generally, nanoparticles described herein contain silica (SiO₂) and optionally may contain a clay component. In various embodiments, the nanoparticles have a relatively high silica content of, for example, at least about 50 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %. In various embodiments, the nanoparticles consist essentially of or consist of silica. It is to be understood that when referring to the nanoparticles as consisting essentially of or consisting of silica that this allows surface modification thereof to provide surface modified nanoparticles.

Suitable clay components of the nanoparticles include alumina (Al₂O₃), kaolinite (Al₂Si₂O₅(OH)₄), and combinations thereof.

In certain embodiments, the silica nanoparticles have an alumina content of at least about 5 wt %, at least about 10 wt %, at least about 20 wt %, at least about 30 wt %, at least about 40 wt %, of at least about 50 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %.

In these and other embodiments, the silica nanoparticles may have an alumina content of from about 5 wt % to about 100 wt %, from about 10 wt % to about 90 wt %, from about 20 wt % to about 75 wt %, from about 30 wt % to about 75 wt %, from about 40 wt % to about 75 wt %, from about 50 wt % to about 75 wt %, from about 60 wt % to about 75 wt %, from about 65 wt % to about 75 wt %, from about 70 wt % to about 100 wt %, from about 75 wt % to about 100 wt %, from about 80 wt % to about 100 wt %, from about 85 wt % to about 100 wt %, from about 90 wt % to about 100 wt %, or from about 95 wt % to about 100 wt %.

When including a clay component(s), in certain embodiments, the silica nanoparticles have a silica content of at least about 5 wt %, at least about 10 wt %, at least about 20 wt %, at least about 30 wt %, at least about 40 wt %, of at least about 50 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %.

In these and other embodiments, the silica nanoparticles have a silica content of from about 5 wt % to about 100 wt %, from about 10 wt % to about 90 wt %, from about 20 wt % to about 75 wt %, from about 30 wt % to about 75 wt %, from about 40 wt % to about 75 wt %, from about 50 wt % to about 75 wt %, from about 60 wt % to about 75 wt %, from about 65 wt % to about 75 wt %, from about 70 wt % to about 100 wt %, from about 75 wt % to about 100 wt %, from about 80 wt % to about 100 wt %, from about 85 wt % to about 100 wt %, from about 90 wt % to about 100 wt %, or from about 95 wt % to about 100 wt %.

As detailed herein, it is currently believed one or more surface modifications of the nanoparticles provide and/or contribute to one or more advantageous properties of the present compositions. In certain embodiments, the surface modification involves the presence of one or more functional groups at the surface of the silica-based nanoparticles. Typically, the functional groups are selected from one or more silane groups. Often, the silane groups are selected from alkyl silanes, amino silanes, acrylic silanes, vinyl silanes, and combinations thereof.

In this regard it is to be understood the proportion of functional (e.g., silane) groups providing the surface modification indicates the concentration based on the total weight of the silica nanoparticles including the surface modification. Likewise, the proportions of silica, clay, and alumina listed above may be in reference to the silica-based nanoparticles with and without surface modification.

Organic Solvent(s)

Suitable organic solvents include alkyl glycols, polyols, and glycol ethers. Exemplary alkyl glycol diols include propylene glycol, butyl glycol, neopentyl glycol, ethylene glycol, 2-methyl-2,4-pentanediol, and combinations thereof. In accordance with certain embodiments, the organic solvent is an alkyl glycol diol selected from propylene glycol, butyl glycol, ethylene glycol, and combinations thereof. In certain embodiments, the organic solvent is butyl glycol. In still further embodiments, the organic solvent is an alky glycol triol including, for example, glycerin.

Further in accordance with the present invention, the organic solvent may be a glycol ether. Suitable glycol ethers include propylene, n-butyl glycol ether, dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof.

In certain embodiments, the glycol ether is selected from the group consisting of propylene glycol, n-butyl glycol ether, butyl glycol, butyl carbitol, and combinations thereof.

In various embodiments, the organic solvent is selected from the group consisting of glycols, alcohols, glycol ethers, and combinations thereof. In certain embodiments, the compositions include one, two or three organic solvents.

In certain embodiments the composition includes one, two, or three glycol and/or glycol ether solvents.

In various embodiments, the one or more organic solvents are selected from the group consisting of propylene glycol, glycerin, ethylene glycol, butyl carbitol, propylene glycol n-butyl ether, butyl glycol, polyethylene glycol, hexylene glycol, and combinations thereof.

Typically, the total proportion of solvents is at least about 2 wt %, at least about 5 wt %, at least about 10 wt %, at least about 15 wt %, at least about 20 wt %, or at least about 25 wt %.

For example, in certain embodiments the total proportion of organic solvents is from about 5 wt % to about 30 wt %, from about 5 wt % to about 15 wt %, or from about 2 wt % to about 15 wt %.

Surfactant(s)

The surfactant component of the compositions of the present invention generally includes one or more anionic surfactants and one or more amphoteric surfactants.

Suitable anionic surfactants include C8-C22 sulfonate surfactants, C8-C22 sulfate surfactants and branched and/or linear ethoxylated C8-C16 sulfate surfactants.

In certain embodiments, C8-C22 sulfonate surfactant or C8-C22 sulfate surfactant is the lone anionic surfactant. In other embodiments, both a C8-C22 sulfonate surfactant or C8-C22 sulfate surfactant and a branched and/or linear ethoxylated sulfate C8-C16 sulfate surfactant is also included.

Any C8-C22 sulfonate surfactant or C8-C22 sulfate surfactant is typically included in a concentration of from about 0.5 wt % to about 10 wt % (e.g., from about 0.5 wt % to about 7 wt %), from about 1 wt % to about 10 wt %, or from about 1 wt % to about 9 wt %.

Any branched and/or linear ethoxylated C8-C16 sulfate surfactant is typically present in a concentration of from about 1 wt % to about 10 wt % (e.g., about 1 wt % to about 8 wt %) or from about 5 wt % to about 20 wt %.

Suitable amphoteric surfactants include C8-C22 betaine surfactants and C8-C22 sultaine surfactants.

Any C8-C22 betaine surfactant is typically included in a concentration of from about 2 wt % to about 25 wt %, from about from about 2 wt % to about 20 wt %, from about 2 wt % to about 15 wt %, or from about 2 wt % to about 12 wt %.

Any C8-C22 sultaine surfactant is typically included in a concentration of from about 2 wt % to about 25 wt %, from about from about 2 wt % to about 20 wt %, from about 2 wt % to about 15 wt %, or from about 2 wt % to about 12 wt %.

Suitable amphoteric surfactants include C8-C22 betaine surfactants and C8-C22 sultaine surfactants.

Other suitable surfactants include dipropionate surfactants.

Suitable dipropionate surfactants include C6-C14 alkyl-iminodipropionate surfactants.

Any C6-C14 alkyl-iminodipropionate surfactants at a concentration of a least about 0.1 wt %, or from about 0.1 wt % to about 3 wt %.

In various embodiments, the composition comprises one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, dipropionate surfactants, and combinations thereof.

In certain other embodiments, the composition comprises a hydrocarbon surfactant selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof.

Alcohol(s)

Optionally, the compositions of the present invention may include one or more alcohols. Suitable alcohols for use in the compositions of the present invention include linear alcohols (e.g., C6-C16 linear alcohols and C8-C16 linear alcohols), branched alcohols (e.g., C6-C16 branched alcohols and C8-C16 branched alcohols), and combinations thereof. Typically, any linear alcohol, branched alcohol, or combination thereof is present in a concentration of from about 0.3 wt % to about 2.5 wt %, or from about 0.3 wt % to about 2.0 wt % of the concentrate.

Biopolymer(s)

Optionally, the compositions of the present invention may also include a biopolymer component. The biopolymer component may include one or more (e.g., two or three) biopolymers with the overall biopolymer component typically present in a concentration of from about 0.2 wt % to about 2.0 wt %.

Suitable biopolymers include alginate, acacia, agar, carrageenan, gellan gum, guar gum, inulin, konjac, locust bean gum, pectin, tara gum, carboxymethylcellulose (CMC), xanthan gum, carrageenan, diutan gum, scleroglucan, chitin, modified guar gum, casein, welan gum, and combinations thereof.

In various embodiments, the biopolymer is selected from the group consisting of diutan gum, xanthan gum, guar gum, welan gum, gellan gum, and combinations thereof.

Further in accordance with the foregoing, firefighting foam concentrates typically contain water in amount defined by any of the following values, in an amount defined any of the following values as a lower or upper limit, and/or in an amount defined by range defined by two of the following values: about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or about 95 wt %.

Methods for Preparing Concentrates

Various aspects of the present invention involve methods for preparing firefighting foam concentrates which include methods for preparing surface modified silica-containing and/or silica-based nanoparticles.

The surface modified nanoparticles are generally prepared by a process involving combining a compound containing a functional group (e.g., silane group) and a grafting polymer along with suitable nanoparticles.

Suitable silane groups may be selected from alkyl silanes, amino silanes, acrylic silanes, vinyl silanes, and combinations thereof. Suitable grafting polymers may be selected from poly(lactide) (PLA), poly(lactide-co-glycolide) (PLGA) copolymers, poly (ε-caprolactone) (PCL), poly (amino acids), alginate, chitosan, gelatin, albumin, and combinations thereof.

To prepare a firefighting foam concentrate of the present invention, the surface modified nanoparticles are combined with one or more of the components listed above.

Use and Performance

The compositions of the present invention are suitable for use in methods for combatting and/or extinguishing a Class-B fire where a composition is applied directly or indirectly onto a Class-B fire.

Various embodiments of the present invention are also directed to firefighting foam solutions containing firefighting foam concentrates of the present invention and water.

Typically, such foam solutions contain at least or about 1 wt %, at least or about 2 wt %, at least or about 3 wt %, at least or about 4 wt %, at least or about 5 wt %, or at least or about 6 wt % of the foam concentrate. That is, the foam solutions are typically prepared from the foam concentrate by dilution with water at a dilution ratio (concentrate to water) of from 1:99 to 6:94.

Incorporating surface-modified nanoparticles has been discovered to improve the polar solvent resistance of firefighting foams prepared from compositions of the present invention. Accordingly, various aspects of the present invention also include methods for improving the polar fuel (e.g., isopropyl alcohol, IPA) resistance of a firefighting foam, which include incorporating one or more surface modified nanoparticles into a firefighting foam concentrate, in particular surface modified silica containing or silica-based nanoparticles.

Advantageously, compositions of the present invention exhibit one or more desired properties when subjected to various testing, including:
satisfying nonpolar fuel (heptane) fire testing in fresh water and sea water under UL standard 162; and/or
exhibiting foam expansion ratio of at least about 5 when lab tested in accordance with UL standard 162 for a premix solution containing one or more surface modified nanoparticles in a concentration in the range of from 30 ppm to 1500 ppm; and/or
exhibiting foam expansion of at least about 9% (e.g., from about 10% to about 20%) when testing in sea water and sea water containing high suspended solids (HSS) in accordance with ASTM D1141-98; and/or
satisfying one or more standards listed in International Civil Aviation Organization (ICAO) Airport Services Manual, 4^{th} edition, 2015: and/or
meeting UL 162 Standard for foam equipment and Liquid Concentrates (8^{th} edition).

Having described the invention in detail, it will be apparent that modifications and variations are possible without departing from the scope of the invention defined in the appended claims.

### EXAMPLES

The following non-limiting examples are provided to further illustrate the present invention.

### Example 1

1. Screening Nanoparticles for Firefighting Foam

Nanoparticles were studied having different surface grafting groups. As listed in Table 1, the grafting groups include amino silane, methacrylic silane, and vinyl silane.

TABLE 1
Nanoparticles and surface grafting information

| Sample ID | Properties |
|---|---|
| 1 | amino silane based, powder |
| 2 | methacrylic silane based, powder |
| 3 | vinyl silane based, powder |
| 4 | alkyl silane based, powder |
| 5 | treated with amino silane, powder |
| 6 | treated with methacrylic silane, powder |
| 7 | fine particle size distribution, powder |
| 8 | Calcined Sample7, powder |
| 9 | Water soluble silica dispersion |
| 10 | Stable and water-soluble aqueous silica dispersion |

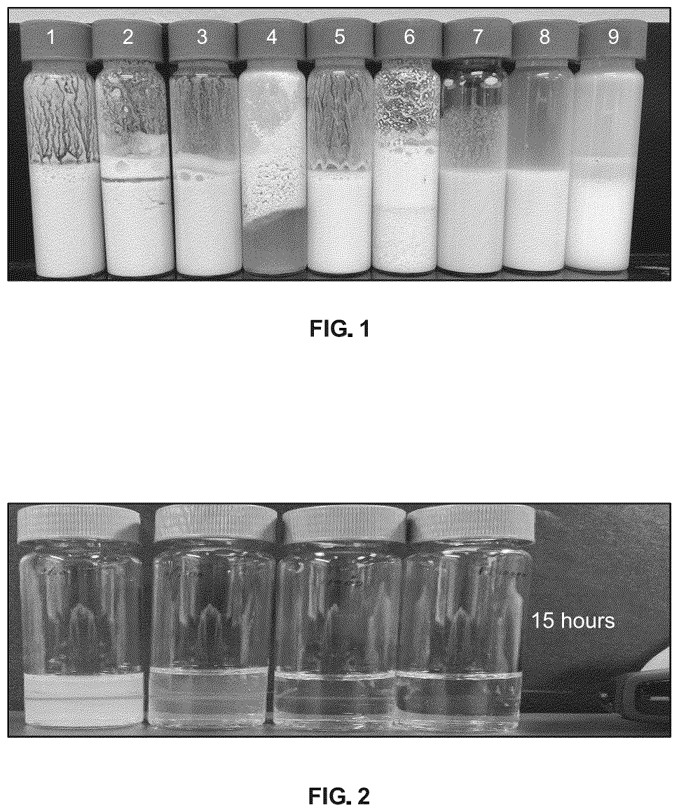

1.1 The samples were tested for foaming properties, solubility, and stability in water. As shown in FIG. 1, the nanoparticles with amino silane (Sample 1), methacrylic silane (Sample 2), and vinyl silane (Sample 3) grafting groups have good foamability and acceptable dispersion in fresh water. The nanoparticle with alkyl modification (Sample 4) appeared to be too hydrophobic for the purpose of this study.

FIG. 2 displays stable nanoparticles for Sample 10 (alkyl modified nanoparticles) at various concentrations after storage for 15 hours. The nanoparticle concentrations are 34000 parts per million (ppm), 3400 ppm, 340 ppm, and 34 ppm (Left (L)-Right (R)).

1.2 Increase of Foam Expansion and Drainage Time with Nanoparticle

The following table summarizes formulations tested for various foam performance characteristics when further including surface modified nanoparticles.

TABLE 2
Summary of foam formulations tested with nanoparticle

| | | Formulation | Formulation | Formulation |
|---|---|---|---|---|
| Type | Composition | 1 | 2 | 3 |
| Solvent | Glycol and/or glycol ether | 3%-20% | 5-30% | 5%-15% |
| Anionic | Sulfonate/Sulfate Surfactant (C8-C22) | 0.5%-7% | 0-11% | 1-9% |
| | Branched and/or Linear Ethoxylated | 1-8% | 5-20% | |
| | Sulfate Surfactant (C8-C16) | | | |
| Amphoteric | Betaine Surfactant (C8-C22) | 2-12% | 1-5% | 7-15% |
| | Sultaine Surfactant (C8-C22) | 2-12% | 0-4% | |
| | Sodium alkyl-iminodipropionate (C6-C14) | | | 0-3% |
| Biopolymers | Biopolymers | 0.9-2.0% | 0.9-3% | |
| Alcohol | Linear Alcohol (C6-C16) | | 0-4% | |

The following table provides results for 50% drain time for the specified volumes of Samples 1 (1.1), 2 (1.2), 3 (1.3), and 5 (1.5) prepared from Formulation 1 in Table 2.

TABLE 3
Effect of nanoparticles on drain time

| | | 50% Drain |
|---|---|---|
| | Foam volume, | time |
| Test | mL | (minutes′seconds) |
| Baseline | 660 | 55′32 |
| (Formulation 1) | | |
| 1.1 | 790 | 50′20 |
| 1.2 | 720 | 52′20 |
| 1.3 | 790 | 50′05 |
| 1.5 | 760 | 50′03 |

The addition of nanoparticles into Formulation 1 (the baseline described in Table 2) helps to fast generate viscous foam (flash foaming) during blender test. The foam volume, or expansion ratio is increased in connection with the nanoparticles utilized in Samples 1.1, 1.2, 1.3, and 1.5. The foam 50% drain time is slightly shortened with nanoparticles, but still in a reasonable range for firefighting foam.

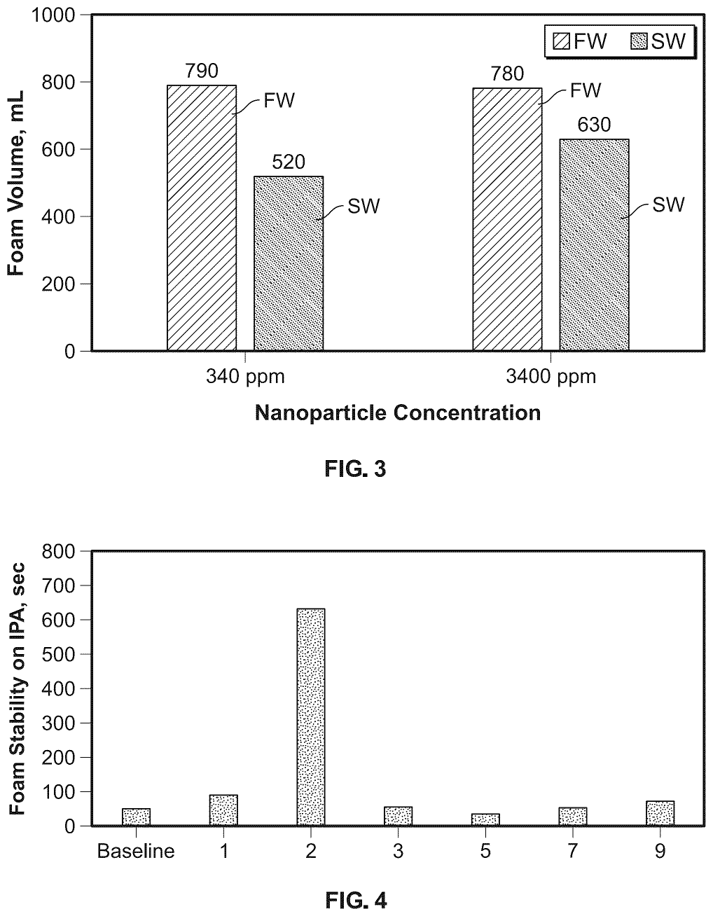

FIG. 3 provides the results of testing the effect of nanoparticle concentration (340 ppm or 3400 ppm) on foam expansion (volume) for alkyl modified nanoparticles (Sample 10).

In fresh water (FW), the addition of nanoparticles helps to rapidly generate viscous foam during blender test at low (340 ppm) or high concentration (3400 ppm). In sea water (SW), lower foam expansion is observed as compared to fresh water. Accordingly, it is currently believed that higher nanoparticle concentration in sea water may be desired to provide desired foam expansion.

TABLE 4
Example of nanoparticle extending foam drainage time

| Sample/Parameter | Foam volume, mL | 50% drain time |
|---|---|---|
| Formulation 3 | 440 | 14′12 |
| (no nanoparticles) | | |
| Formulation 3 with | 470 | 20′23 |
| 2% Sample 1 (3.1) | | |

Table 4 shows the amino silane-based nanoparticle (Sample 1) improves Formulation 3 foam quality. The foam expansion volume increased approximately 2% while the foam drainage time increased by 371 seconds, which is an improvement of 44%.

1.3 Interaction with Biopolymer with Improved IPA Resistance

FIG. 4 includes results of testing for polar fuel (isopropyl alcohol (IPA)) resistance for foams based on Formulation 1 and those including Samples 1 (1.1), 2 (1.2), 3 (1.3), 5 (1.5), 7 (1.7), and 9 (1.9) identified in Table 1.

Specifically, FIG. 4 provides the results of testing for polar fuel (isopropyl alcohol (IPA)) resistance (foam stability in seconds (sec)) for various samples based on Formulation 1.

Often in the firefighting industry, alcohols are added to the foam concentrate to form a polymer membrane on the top of polar fuels to prevent vapor migration. The formulations tested herein are alcohol-free. Thus, the results in FIG. 4 indicate a novel approach for polar fuel firefighting in which it is currently believed the nanoparticles interact with a biopolymer to form a polymer membrane to prevent vapor migration and thus increase the foam resistance to IPA. With the addition of a proper nanoparticle, the foam resistance time to IPA is increased from 48 seconds (Baseline) to 631 seconds (1.2).

The following table provides results for IPA resistance testing in connection with the use of nanoparticles in Formulation 2 (Base).

TABLE 5
Effect of nanoparticles on Formulation 2 IPA resistance

| Sample | IPA tolerance |
|---|---|
| Base | 19′50 |
| 2.1 | 20′38 |
| 2.2 | 16′13 |
| 2.3 | 10′12 |
| 2.5 | 8′10 |
| 2.9 | 27′38 |

These results indicate improved IPA resistance in connection with sample 2.1 (amino silane-based nanoparticle) and sample 2.9 (aqueous silica dispersion).

1.4 Full Scale Fire Test with Nanoparticle

The following results are for use of the nanoparticles in formulations subjected to full scale fire tests. Formulation 1 containing nanoparticles passes heptane fire tests in both fresh water (FW) and salt water (SW) under UL standard 162. As a comparison, Formula 1 without nanoparticles did not expand sufficiently in hard water with high total suspended solids (TSS) and thus could not be subjected to full scale fire tests.

TABLE 7
Fire test results with and without nanoparticle under UL standards
Formulation 1, Tested under UL Standard 162

| | FW with | SW with | SW without |
|---|---|---|---|
| Water | Nano | Nano | Nano |
| Fuel | Heptane | Heptane | Too low |
| Expansion index | 7.71 | 5.8 | expansion |
| 25% Drainage time | 40′42 | about 36′00 | |
| 90% Control, min:s | 0′51 | 0′52 | |
| 99% | 1′27 | 1′40 | |
| Extinguishment, | 1′38 | 2′04 | |
| min:s | Auto extinguish | 7′00 | |
| Burnback 25%, min:s | 0′25 | | |
| Result | Pass | Pass | |
| (min′s = | | | |
| minutes′seconds) | | | |

### EMBODIMENTS

For additional illustration, further and preferred embodiments of the present invention are set forth below.

Embodiment 1 is directed to a firefighting foam concentrate, the concentrate comprising: surface modified silica nanoparticles, wherein the silica nanoparticles have a silica (SiO₂) content of at least about 50 wt %; one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 dipropionate surfactants, and combinations thereof; optionally, one or more biopolymers; and optionally, one or more alcohols, wherein the one or more alcohols are selected from the group consisting of C6-C16 linear alcohols, C6-C16 branched alcohols, and combinations thereof.

Embodiment 2 is the concentrate of Embodiment 1, wherein the silica nanoparticles have a silica content of at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %.

Embodiment 3 is the concentrate of Embodiment 1, wherein the silica nanoparticles consist essentially of silica.

Embodiment 4 is directed to a firefighting foam concentrate, the concentrate comprising: surface modified silica nanoparticles, wherein the silica nanoparticles comprise silica (SiO₂) and a clay component comprising alumina (Al₂O₃), kaolinite (Al₂Si₂O₅(OH)₄), or a combination thereof; one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, dipropionate surfactants, and combinations thereof; optionally, one or more biopolymers; and optionally, one or more alcohols, wherein the one or more alcohols are selected from the group consisting of C6-C16 linear alcohols, C6-C16 branched alcohols, and combinations thereof.

Embodiment 5 is directed to the concentrate of Embodiment 4, wherein the silica nanoparticles have an alumina content of at least about 5 wt %, at least about 10 wt %, at least about 20 wt %, at least about 30 wt %, at least about 40 wt %, of at least about 50 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %.

Embodiment 6 is directed to the concentrate of Embodiment 4, wherein the silica nanoparticles have an alumina content of from about 5 wt % to about 100 wt %, from about 10 wt % to about 90 wt %, from about 20 wt % to about 75 wt %, from about 30 wt % to about 75 wt %, from about 40 wt % to about 75 wt %, from about 50 wt % to about 75 wt %, from about 60 wt % to about 75 wt %, from about 65 wt % to about 75 wt %, from about 70 wt % to about 100 wt %, from about 75 wt % to about 100 wt %, from about 80 wt % to about 100 wt %, from about 85 wt % to about 100 wt %, from about 90 wt % to about 100 wt %, or from about 95 wt % to about 100 wt %.

Embodiment 7 is directed to the concentrate of Embodiment 5 or 6, wherein the silica nanoparticles have a silica content of at least about 5 wt %, at least about 10 wt %, at least about 20 wt %, at least about 30 wt %, at least about 40 wt %, of at least about 50 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %.

Embodiment 8 is directed to the concentrate of Embodiment 5 or 6, wherein the silica nanoparticles have a silica content of from about 5 wt % to about 100 wt %, from about 10 wt % to about 90 wt %, from about 20 wt % to about 75 wt %, from about 30 wt % to about 75 wt %, from about 40 wt % to about 75 wt %, from about 50 wt % to about 75 wt %, from about 60 wt % to about 75 wt %, from about 65 wt % to about 75 wt %, from about 70 wt % to about 100 wt %, from about 75 wt % to about 100 wt %, from about 80 wt % to about 100 wt %, from about 85 wt % to about 100 wt %, from about 90 wt % to about 100 wt %, or from about 95 wt % to about 100 wt %.

Embodiment 9 is directed to concentrate of any of the preceding Embodiments, wherein the surface-modified silica nanoparticles comprise one or more silane groups.

Embodiment 10 is directed to the concentrate of Embodiment 9, wherein the one or more silane groups are selected from alkyl silanes, amino silanes, acrylic silanes, vinyl silanes, and combinations thereof.

Embodiment 11 is directed to the concentrate of any of the preceding Embodiments, wherein the one or more solvents are selected from the group consisting of propylene, n-butyl glycol ether, dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof.

Embodiment 12 is directed to the concentrate of any of the preceding Embodiments, wherein the one or more organic solvents are selected from the group consisting of propylene glycol, glycerin, ethylene glycol, butyl carbitol, propylene glycol n-butyl ether, butyl glycol, polyethylene glycol, hexylene glycol, and combinations thereof.

Embodiment 13 is directed to the concentrate of any of the preceding Embodiments, wherein the one or more solvents constitute at least about 2 wt %, at least about 5 wt %, at least about 10 wt %, at least about 15 wt %, at least about 20 wt %, or at least about 25 wt % of the concentrate.

Embodiment 14 is directed to the concentrate of any of the preceding Embodiments, wherein the one or more solvents constitute from about 5 wt % to about 30 wt %, from about 5 wt % to about 15 wt %, or from about 2 wt % to about 15 wt % of the concentrate.

Embodiment 15 is directed to the concentrate of any of the preceding Embodiments, wherein the concentrate comprises a hydrocarbon surfactant selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof.

Embodiment 16 is directed to the concentrate of any of the preceding Embodiments, wherein the concentrate comprises a C8-C22 sulfonate surfactant and/or a C8-C22 sulfate surfactant at a concentration of from about 0.5 wt % to about 10 wt %, from about 0.5 wt % to about 7 wt %, from about 1 wt % to about 10 wt %, or from about 1 wt % to about 9 wt %.

Embodiment 17 is directed to the concentrate of any of the preceding Embodiments, wherein the concentrate comprises a branched and/or linear ethoxylated C8-C16 sulfate surfactant at a concentration of from about 1 wt % to about 10 wt %, from about 1 wt % to about 8 wt %, or from about 5 wt % to about 20 wt %.

Embodiment 18 is directed to the concentrate of any of the preceding Embodiments, wherein the concentrate comprises a C8-C22 betaine surfactant at a concentration of from about 2 wt % to about 25 wt %, from about from about 2 wt % to about 20 wt %, from about 2 wt % to about 15 wt %, or from about 2 wt % to about 12 wt %.

Embodiment 19 is directed to the concentrate of any of the preceding Embodiments, wherein the concentrate comprises a C8-C22 sultaine surfactant at a concentration of from about 2 wt % to about 25 wt %, from about from about 2 wt % to about 20 wt %, from about 2 wt % to about 15 wt %, or from about 2 wt % to about 12 wt %.

Embodiment 20 is directed to the concentrate of any of the preceding Embodiments, wherein the concentrate comprises a C6-C14 alkyl-iminodipropionate surfactant at a concentration of a least about 0.1 wt %, or from about 0.1 wt % to about 3 wt %.

Embodiment 21 is directed to the concentrate of any of the preceding Embodiments, wherein the one or more biopolymers are selected from the group consisting of alginate, acacia, agar, carrageenan, gellan gum, guar gum, inulin, konjac, locust bean gum, pectin, tara gum, carboxymethylcellulose (CMC), xanthan, diutan gum, scleroglucan, chitin, modified guar gum, casein, welan gum, and combinations thereof.

Embodiment 22 is directed to the concentrate of any of the preceding Embodiments, wherein the one or more biopolymers are selected from the group consisting of diutan gum, xanthan gum, guar gum, welan gum, gellan gum, and combinations thereof.

Embodiment 23 is directed to the concentrate of any of the preceding Embodiments, wherein the one or more biopolymers constitute from about 0.2 wt % to about 2.0 wt % of the concentrate.

Embodiment 24 is directed to the concentrate of any of the preceding Embodiments, wherein the one or more alcohols constitute from about 0.3 wt % to about 0.25 wt %, or from about 0.3 wt % to about 2.0 wt % of the concentrate.

Embodiment 25 is directed to a firefighting foam solution composition, the foam solution prepared by diluting any of the concentrates of the preceding claims with water.

Embodiment 26 is directed to a firefighting foam solution composition, the foam solution comprising any of the concentrates of the preceding Embodiments and water.

Embodiment 27 is directed to a firefighting foam composition prepared from any of the concentrates or solutions of the present Embodiments, wherein the foam composition: satisfies nonpolar fuel (heptane) fire testing in fresh water and sea water under UL standard 162; and/or exhibits foam expansion ratio of at least about 5 when lab tested in accordance with UL standard 162 for a premix solution containing one or more surface modified nanoparticles in a concentration in the range of from 30 ppm to 1500 ppm; and/or exhibits foam expansion of at least about 9% (or from about 10% to about 20%) when testing in sea water and sea water containing high suspended solids (HSS) in accordance with ASTM D1141-98; and/or satisfies one or more standards listed in International Civil Aviation Organization (ICAO) Airport Services Manual, 4^{th} edition, 2015: and/or UL 162 Standard for foam equipment and Liquid Concentrates (8^{th} edition).

Embodiment 28 is directed to a method for increasing the resistance of a firefighting foam to a polar solvent (isopropyl alcohol), the method comprising: introducing surface modified silica nanoparticles into a firefighting foam concentrate, wherein the firefighting foam concentrate comprises: one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 alkyl-iminodipropionate surfactants, and combinations thereof; optionally, one or more biopolymers; and optionally, one or more alcohols, wherein the one or more alcohols are selected from the group consisting of C6-C16 linear alcohols, C6-C16 branched alcohols, and combinations thereof.

Embodiment 29 is directed to a method for preparing a firefighting foam concentrate, the method comprising: preparing one or more surface modified nanoparticles by combining one or more silica containing nanoparticles, a compound containing a silane group, and a grafting polymer, wherein the one or silane groups are selected from alkyl silanes, amino silanes, acrylic silanes, vinyl silanes, and combinations thereof, and the grafting polymer is selected from poly(lactide) (PLA), poly(lactide-co-glycolide) (PLGA) copolymers, poly (C-caprolactone) (PCL), poly (amino acids), alginate, chitosan, gelatin, albumin, and combinations thereof; and combining the one or more surface modified nanoparticles with one or more other components of the firefighting foam concentrate, the one or more other components selected from the group consisting of: one or more organic solvents, wherein the one or more organic solvents comprise one or more glycols and/or one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 alkyl-iminodipropionate surfactants, and combinations thereof; one or more biopolymers; and one or more alcohols, wherein the one or more alcohols are selected from the group consisting of C6-C16 linear alcohols, C6-C16 branched alcohols, and combinations thereof.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, members and/or sections, these elements, components, members and/or sections should not be limited by these terms. These terms may be only used to distinguish one element, component, member or section from another element, component, member or section. Terms such as “first,” “second,” and other numerical terms when used herein do not imply a sequence or order unless clearly indicated by the context. Thus, a first element, component, member or section discussed below could be termed a second element, component, member or section without departing from the teachings of the example embodiments.

In view of the above, it will be seen that the several objects of the invention are achieved, and other advantageous results attained.

As various changes could be made in the above products and methods without departing from the scope of the invention, it is intended that all matter contained in the above

What is claimed is:

1. A firefighting foam concentrate, the concentrate comprising:
surface modified silica nanoparticles, wherein the silica nanoparticles have a silica (SiO₂) content of at least about 3 wt %;
one or more organic solvents, wherein the one or more organic solvents comprise one or more glycols and/or one or more glycol ethers;
anionic surfactants comprising: (i) a first anionic surfactant comprising a C8-C22 sulfonate surfactant, and/or a C8-C22 sulfate surfactant; and (ii) a second anionic surfactant comprising a branched ethoxylated sulfate C8-C16 sulfate surfactant, and/or a linear ethoxylated sulfate C8-C16 surfactant;
amphoteric surfactants comprising a C8-C22 betaine surfactant, and a C8-C22 sultaine surfactant, and
optionally, one or more biopolymers; and
optionally, one or more alcohols, wherein the one or more alcohols are selected from the group consisting of C6-C16 linear alcohols, C6-C16 branched alcohols, and combinations thereof.

2. The concentrate of claim 1, wherein the silica nanoparticles have a silica content of at least about 50 wt %.

3. The concentrate of claim 1, wherein the silica nanoparticles consist essentially of silica.

4. The concentrate of claim 1, wherein the surface modified silica nanoparticles further comprise a clay component comprising alumina (Al₂O₃), kaolinite (Al₂Si₂O₅(OH)₄), or a combination thereof.

5. (canceled)

6. The concentrate of claim 1, wherein the surface-modified silica nanoparticles comprise one or more silane groups, wherein the one or more silane groups are selected from alkyl silanes, amino silanes, acrylic silanes, vinyl silanes, and combinations thereof.

7. (canceled)

8. The concentrate of claim 1, wherein the surface-modified silica nanoparticles comprise one or more alkyl groups.

9. The concentrate of claim 1, wherein the one or more solvents are selected from the group consisting of propylene, n-butyl glycol ether, dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof.

10. (canceled)

11. (canceled)

12. The concentrate of claim 1, wherein the one or more solvents constitute from about 5 wt % to about 30 wt % of the concentrate.

13. The concentrate of claim 1, wherein the anionic surfactants comprise a C8-C22 sulfonate surfactant and a branched or linear ethoxylated C8-C16 sulfate surfactant, and wherein the concentrate comprises the anionic surfactants in a proportion of from about 0.5 wt % to about 10 wt %.

14. (canceled)

15. The concentrate of claim 1, wherein the anionic surfactants comprise a C8-C22 sulfate surfactant and a branched or linear ethoxylated C8-C16 sulfate surfactant, and wherein the concentrate comprises the anionic surfactants in a proportion of from about 0.5 wt % to about 10 wt %.

16. (canceled)

17. The concentrate of claim 1, wherein the concentrate comprises the C8-C22 betaine surfactant at a concentration of from about 2 wt % to about 15 wt % and/or the C8-C22 sultaine surfactant at a concentration of from about 2 wt % to about 15 wt %.

18. (canceled)

19. The concentrate of claim 1, wherein the concentrate further comprises a C6-C14 alkyl-iminodipropionate surfactant at a concentration of from about 0.1 wt % to about 3 wt %.

20. The concentrate of claim 1 comprising one or more biopolymers, wherein the one or more biopolymers are selected from the group consisting of alginate, acacia, agar, carrageenan, gellan gum, guar gum, inulin, konjac, locust bean gum, pectin, tara gum, carboxymethylcellulose (CMC), xanthan, diutan gum, scleroglucan, chitin, modified guar gum, casein, welan gum, and combinations thereof, and wherein the one or more biopolymers constitute from about 0.2 wt % to about 2.0 wt % of the concentrate.

21. (canceled)

22. The concentrate of claim 1 comprising one or more alcohols, wherein the one or more alcohols comprise a C8-C16 linear alcohol and/or a C8-C16 branched alcohol and constitute from about 0.3 wt % to about 0.25 wt % of the concentrate.

23. The concentrate of claim 1, wherein the concentrate is fluorine-free, silicone-free, and/or free of any fatty alcohol defoamer.

24. A firefighting foam solution composition, the foam solution prepared by diluting the concentrate of claim 1 with water.

25. A firefighting foam solution composition, the foam solution comprising the concentrate of claim 1 and water.

26. A firefighting foam composition prepared from the concentrate of claim 1, wherein the foam composition:
satisfies nonpolar fuel (heptane) fire testing in fresh water and sea water under UL standard 162; and/or
exhibits foam expansion ratio of at least about 5 when lab tested in accordance with UL standard 162 for a premix solution containing one or more surface modified nanoparticles in a concentration in the range of from 30 ppm to 1500 ppm; and/or
exhibits foam expansion of at least about 9% (or from about 10% to about 20%) when testing in sea water and sea water containing high suspended solids (HSS) in accordance with ASTM D1141-98; and/or
satisfies one or more standards listed in International Civil Aviation Organization (ICAO) Airport Services Manual, 4^{th} edition, 2015: and/or
UL 162 Standard for foam equipment and Liquid Concentrates (8^{th} edition).

27. A method for increasing the resistance of a firefighting foam to a polar solvent comprising isopropyl alcohol, the method comprising:
introducing surface modified silica nanoparticles into a firefighting foam concentrate, wherein the firefighting foam concentrate comprises:
one or more organic solvents, wherein the one or more organic solvents comprise one or more glycols and/or one or more glycol ethers;
one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 alkyl-iminodipropionate surfactants, and combinations thereof;
optionally, one or more biopolymers; and
optionally, one or more alcohols, wherein the one or more alcohols are selected from the group consisting of C6-C16 linear alcohols, C6-C16 branched alcohols, and combinations thereof.

28. A method for preparing a firefighting foam concentrate, the method comprising:
preparing one or more surface modified nanoparticles by combining one or more silica containing nanoparticles, a compound containing a silane group, and a grafting polymer, wherein the one or silane groups are selected from alkyl silanes, amino silanes, acrylic silanes, vinyl silanes, and combinations thereof, and the grafting polymer is selected from poly(lactide) (PLA), poly(lactide-co-glycolide) (PLGA) copolymers, poly (ε-caprolactone) (PCL), poly (amino acids), alginate, chitosan, gelatin, albumin, and combinations thereof; and
combining the one or more surface modified nanoparticles with one or more other components of the firefighting foam concentrate, the one or more other components selected from the group consisting of:
one or more organic solvents, wherein the one or more organic solvents comprise one or more glycols and/or one or more glycol ethers;
one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, C6-C14 alkyl-iminodipropionate surfactants, and combinations thereof;
one or more biopolymers; and
one or more alcohols, wherein the one or more alcohols are selected from the group consisting of C6-C16 linear alcohols, C6-C16 branched alcohols, and combinations thereof.
